(19) United States
(12) Patent Application Publication
(10) Pub. No.: US 2015/0275671 A1
(43) Pub. Date: Oct. 1, 2015

(54) METHOD OF LOCALLY TREATING A PART MADE OF POROUS COMPOSITE MATERIAL

(71) Applicant: HERAKLES, Le Haillan (FR)

(72) Inventors: Eric Conete, Merignac (FR); Eric Philippe, Merignac (FR)

(21) Appl. No.: 14/434,496

(22) PCT Filed: Oct. 8, 2013
(86) PCT No.: PCT/FR2013/052388

§ 371 Date: Apr. 9, 2015

(30) Foreign Application Priority Data
Oct. 9, 2012 (FR) 1259600

(51) Int. Cl. F01D 5/00; C04B 41/00; C04B 41/45; C04B 41/85; C04B 41/50

(52) U.S. Cl. CPC F01D 5/005; C04B 41/85; C04B 41/50; C04B 41/4572; C04B 41/0072

(57) ABSTRACT

A method of locally treating a portion of a part made of composite material including fiber reinforcement densified by a matrix, the material presenting internal pores, the method including: determining a quantity of infiltration composition as a function of a volume of the portion of the part to be treated, the infiltration composition including at least silicon; placing the determined quantity of infiltration composition in contact with pores opening out in a surface of the portion of the part to be treated; and applying heat treatment at a temperature higher than or equal to a melting temperature of the infiltration composition so as to impregnate the portion with the treatment composition and fill in the pores present in the portion.

### BACKGROUND OF THE INVENTION

Thermostructural composite materials are known for their good mechanical properties and their ability to conserve these properties at high temperature. They comprise carbon/carbon (C/C) composite materials made up of carbon fiber reinforcement densified by a carbon matrix, and ceramic matrix composite (CMC) materials formed by reinforcement made of refractory (carbon or ceramic) fibers densified by a matrix that is ceramic, at least in part. Examples of CMC materials are C/SiC composites (carbon fiber reinforcement and silicon carbide matrix), C/C-SiC composites (carbon fiber reinforcement and matrix comprising a carbon phase, generally closer to the fibers, together with a silicon carbide phase), and SiC/SiC composites (reinforcing fibers and matrix made of silicon carbide). An interphase layer may be interposed between the reinforcing fibers and the matrix in order to improve the mechanical strength of the material.

The usual methods of obtaining thermostructural composite material parts are the method using a liquid technique and the method using a gaseous technique.

The liquid technique method consists in making a fiber preform that is substantially in the shape of the part that is to be made, and that is to constitute the reinforcement of the composite material, and in impregnating the preform with the liquid composition containing a precursor for the material of the matrix. The precursor is usually in the form of a polymer, such as a resin, possibly diluted in a solvent. The precursor is transformed into a refractory phase by heat treatment, after eliminating the solvent, if any, and curing the polymer. A plurality of successive impregnation cycles may be performed in order to achieve the desired degree of densification. By way of example, liquid precursors for carbon may be resins having a relatively high coke content such as phenolic resins, while liquid precursors for ceramic, in particular SiC, may be resins of the polycarbosilane (PCS), or polytitanocarbosilane (PTCS), or polysilazane (PSZ) type.

The gaseous technique method consists in chemical vapor infiltration (CVI). The fiber preform corresponding to a part that is to be made is placed in an oven into which a reaction gas is admitted. The pressure and the temperature that exist in the oven and the composition of the gas are selected so as to enable the gas to diffuse within the pores of the preform in order to form the matrix by depositing a solid material in contact with the fibers, which material results from a component of the gas decomposing or from a reaction between a plurality of components. By way of example, gaseous precursors for carbon may be hydrocarbons that give carbon by cracking, such as methane, or a gaseous precursor for a ceramic, in particular SiC, which precursor may be methyltricholosilane (MTS) giving SiC by decomposition of the MTS (possibly in the presence of hydrogen).

There also exist combined methods making use both of liquid techniques and gaseous techniques.

Because of their properties, such thermostructural composite materials find applications in a variety of fields, for the purpose of making parts that are to be subjected to high levels of thermomechanical stress, e.g. in the aviation, space, or nuclear fields.

Nevertheless, whatever the densification method used, parts made of thermostructural composite material always present internal porosity that is open, i.e. in communication with the outside of the part. This porosity comes from the inevitably incomplete nature of the densification of fiber preforms. It gives rise to the presence of pores of greater or smaller dimensions that are in communication with one another.

In spite of the presence of these pores, such parts generally present very satisfactory mechanical strength. Nevertheless, in certain circumstances, parts made of composite material may be subjected locally to very large mechanical stresses, as happens for example to the root of an aeroengine blade where the crushing and compression forces to which the blade is subjected are concentrated.

The presence of pores in the portion of the part that is stressed in this way can locally weaken the mechanical strength of the part. Consequently, there is a need to reinforce a thermostructural composite material part locally.

The same applies to portions of parts made of thermostructural composite material, where such portions constitute portions for fastening to or rubbing against other parts, in particular parts made of metal, and are therefore subjected to mechanical forces that are greater than the remainder of the part.

### OBJECT AND SUMMARY OF THE INVENTION

An object of the invention is to provide a solution enabling a porous composite material part to be reinforced locally.

This object is achieved by a method of locally treating a portion of a part made of composite material comprising fiber reinforcement densified by a matrix, said material presenting internal pores, the method comprising the following steps:

determining a quantity of infiltration composition as a function of the volume of the portion of the part to be treated, the infiltration composition comprising at least silicon;

placing the determined quantity of infiltration composition in contact with pores opening out in the surface of the portion of the part to be treated; and

applying heat treatment at a temperature higher than or equal to the melting temperature of the infiltration composition so as to impregnate said portion with the treatment composition and fill in the pores present in said portion.

Thus, by the method of the invention, it is possible to treat only one or more portions of a part that need reinforcing. It is thus possible to reinforce a part locally in a determined portion that is subjected to mechanical stresses that are large compared with the remainder of the part. The infiltration composition infiltrates by capillarity only into the intended portion and not beyond since the quantity of infiltration composition that is used is determined as a function of the volume of the portion that is to be infiltrated. This therefore limits the increase in weight of the part compared with infiltrating all of the material of the part by a method of the melt or slurry casting type.

In a first aspect of the method of the invention, the infiltration composition comprises silicon or one of its alloys, such as in particular SiTi, SiMo, or SiNB.

In a second aspect of the invention, the method further comprises a step of machining the portion of the treated part.

In a third aspect of the invention, the part is made of ceramic matrix thermostructural composite material.

The composite material part may correspond in particular to an aeroengine blade comprising at least a blade root and an airfoil, the portion to be treated corresponding to the root of said blade. Under such circumstances, the local reinforcement of the blade root serves to simplify its manufacturing process and makes it possible to envisage omitting the use of an insert in this portion of the blade. Other portions of the blade may be reinforced with the method of the invention, such as portions involved in contact or friction between blades, portions that are fine such as trailing edges, portions that come into contact with portions of the engine stator such as wipers, local portions such as anti-tilting walls, etc.

The composite material part treated by the method of the invention may also correspond to a structural part having at least one connection portion for being mechanically connected to another part, the connection portion corresponding to the portion to be treated. This improves the rigidity of the material of the part in the connection zones and also its ability to withstand tightening forces.

The method of the invention may also be used to treat a composite material part including at least one bearing surface portion that is to come into contact with a metal sealing part, the bearing surface portion corresponding to a portion to be treated. This produces a bearing surface portion that is better at withstanding friction with the metal part, thereby making it possible to maintain sealing over time. In addition, when the composition material of the part has a matrix that is self-healing, i.e. that includes boron or a boron compound, infiltrating the bearing surface portion makes it possible to avoid interactions between boron and the metal material(s) of the sealing part.

The invention also provides a method of repairing a composite material part including at least one damaged portion present in the surface of the part, each damaged portion being treated in accordance with the treatment method of the invention. This method makes it possible in particular to repair a surface state of a composite material part in a portion that has become damaged, e.g. after impacting against some other object.

### BRIEF DESCRIPTION OF THE DRAWINGS

Other characteristics and advantages of the invention appear from the following description of particular implementations of the invention given as non-limiting examples and with reference to the accompanying drawings, in which:

FIGS. 1A, 1B, and 2 are diagrammatic views showing local infiltration of a blade root in accordance with a treatment method of the invention;

FIGS. 3A and 3B are microscope photographs showing a blade root respectively before and after local infiltration by the treatment method of the invention;

FIGS. 4 and 5 are diagrammatic views showing local infiltration of a blade root with the formation of lateral surface coatings in accordance with a treatment method of the invention;

FIGS. 6 to 8 are diagrammatic views showing a damaged portion of a blade being repaired in accordance with the repair method of the invention; and

FIGS. 9 and 10 are diagrammatic views showing local infiltration of connection portions of a structural part in accordance with a treatment method of the invention.

### DETAILED DESCRIPTION OF IMPLEMENTATIONS

The treatment method of the present invention applies in general manner to parts made of composite material.

The term part made of “composite material” is used to mean any part comprising fiber reinforcement densified by a matrix.

The fiber reinforcement is made from a fiber structure, itself made by weaving, assembling, knitting, etc. fibers such as ceramic fibers, e.g. silicon carbide (SiC) fibers, carbon fibers, or indeed fibers made of a refractory oxide, e.g. made of alumina (Al₂O₃). Optionally after shaping and consolidation, the fiber structure is then densified by a matrix which may in particular be a ceramic matrix forming a ceramic matrix composite (CMC) material, or indeed a carbon matrix forming a carbon/carbon (C/C) composite material when used in association with carbon fiber reinforcement. The matrix of the composite material is obtained in known manner using a method based on a liquid technique, a gaseous technique, or a combination of these two techniques.

The method of the invention consists in locally treating (e.g. reinforcing) or repairing parts made of composite material by melting an infiltration composition. With local treatment, e.g. reinforcement treatment, the invention proposes locally adding to the densification of the composite material of the part by locally filling in the residual pores in the zone under consideration by means of the infiltration composition. For local repair, the invention proposes filling in the damaged zone using the infiltration composition. For this purpose, regardless of whether it is used for local treatment or for repair, the infiltration composition is placed directly in contact with pores opening out into the surface of the part.

Consequently, in accordance with the invention, prior to putting the infiltration composition into place and melting it, there is no need to make any coating of a kind for plugging all or some of the pores opening out into the surface of the part in order to prevent the infiltration composition from penetrating pores of the composite material. For example, in the present invention, no ceramic coating of the type described in Document WO 2010/069346 is formed before the infiltration composition is put into place and melted. Such a ceramic coating plugs most of the pores opening out in the surface of the composite material of the part and prevents good penetration of the infiltration composition into the material of the part. Under such circumstances, it is consequently not possible to increase locally the densification of the composite material of the part or to enable the fill-in material obtained from the infiltration composition to attach firmly in the part when repairing a damaged zone.

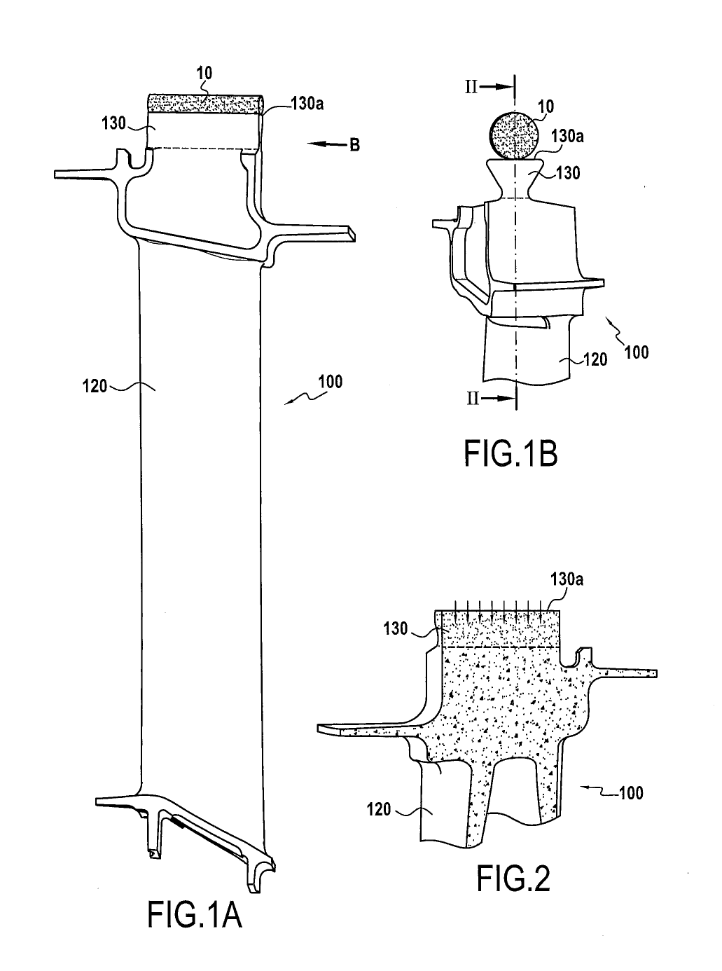

With reference to FIGS. 1A, 1B, and 2, there follows a description of an implementation of a method in accordance with the invention for treating an aeroengine blade. FIGS. 1A and 1B show a blade 100 of a low pressure (LP) turbine rotor, which blade comprises an airfoil 120 and a root 130 formed by a portion of greater thickness, e.g. having a bulb-shaped section. The blade 100 is for mounting on a turbine rotor made of metal (not shown) by engaging the root 130 in a housing of complementary shape formed in the periphery of the rotor. In this example, the blade is made of thermostructural composite material comprising silicon carbide (SiC) fiber reinforcement obtained by three-dimensional or multilayer weaving to provide a single piece made of silicon carbon yarns, the reinforcement being densified by a matrix that is likewise made of SiC.

The root 130 is the portion of the blade where the crushing and compression forces to which the blade is subjected are concentrated. Consequently, the portion of the blade must present mechanical strength that is greater than that of the remainder of the blade. In accordance with the invention, the blade root is reinforced by filling in the pores present in the root. For this purpose, use is made of a silicon-based infiltration composition, i.e. a composition comprising silicon or an alloy of silicon, such as for example SiTi, SiMo, or SiNB.

The infiltration composition is in solid form. In the presently-described example, the infiltration composition is molded in the form of a cord 10 that is placed on the terminal portion 130a of the root 130. The quantity of the treatment composition, in this example the volume of the cord 10, is determined as a function of the volume of the pores to be filled in the root 130.

Once the cord 10 has been put into position on the blade root, the cord and the root are heated to a temperature greater than or equal to the melting temperature of the infiltration composition which, on melting, spreads by capillarity along the fibers in the pores present in the root 130. Since the pores are in communication with one another and since some of them open out into the surface, the infiltration composition spreads also over the surface of the root 130. The blade as infiltrated in this way in its root is then cooled down.

As shown in FIG. 2, a blade 100 is thus obtained having a root 130 in which the pores are filled in by the infiltration composition, thereby enabling the blade root to be reinforced, in particular against compression and crushing stresses.

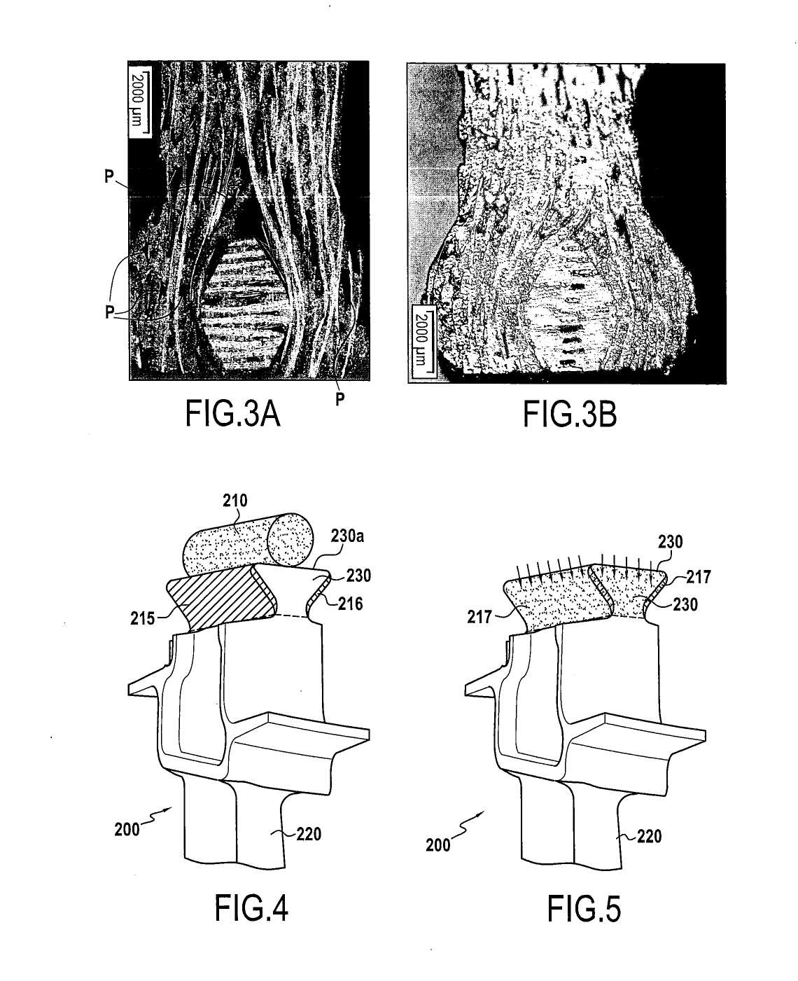

FIG. 3A is a photograph of a section of a blade root made of thermostructural composite material comprising SiC fiber reinforcement densified by a matrix that is likewise made of SiC. The presence of numerous pores P can be observed in the material. FIG. 3B shows a blade root similar to that of FIG. 3A, but after it has been treated with an infiltration composition under the same conditions as those described above. It can be seen that most of the pores have been filled in by the infiltration composition, thereby imparting increased mechanical strength to the blade root, in particular against compression or crushing forces.

In a variant implementation of the treatment method of the invention, a protective coating may also be formed on all or part of the outer surface of the portion of the part that has been infiltrated with the treatment composition. For this purpose, a support material suitable for impregnating the infiltration composition by capillarity is placed on the portions of the outer surface of the part where it is desired to form a protective coating. Such a material may in particular be a powder of refractory particles such as particles of SiC or a texture made from fibers that are preferably of the same kind as the fibers constituting the reinforcement of the part to be treated.

FIG. 4 shows a blade 200 comprising an airfoil 220 and a root 230. In this example, the blade is made of thermostructural composite material comprising reinforcement obtained by three-dimensional or multilayer weaving of SIC yarns to form a single part, the reinforcement being densified by a matrix that is likewise made of SiC. A determined quantity of silicon-based infiltration composition molded in the form of a cord 210 is placed on the terminal portion 230a of the root 230, while two layers 215 and 216 of an SIC powder are deposited respectively on the side faces of the root 230. The cord, the root, and the layers are then raised to a temperature higher than or equal to the melting temperature of the infiltration composition, which then spreads both into the pores of the material present in the blade root and also into the layers 215 and 216.

Once cooled, and as shown in FIG. 5, a blade 200 is obtained having a root 230 with its pores filled in by the infiltration composition and including on its side faces a protective coating 217 constituted by grains of SIC that are bonded together by the infiltration composition. The protective coating 217 as obtained in this way can be machined after it has been formed in order to make the shape of the blade root fit the required tolerances. In addition, when the blade 200 has been densified with a self-healing matrix, the matrix contains one or more boron-based elements that might spoil the metal material of the disk or of the rotor wheel on which the blades are mounted. The protective coating as formed in this way on the surface of the blade root serves to avoid direct contact between the boron-containing elements of the matrix and the disk or wheel made of metal.

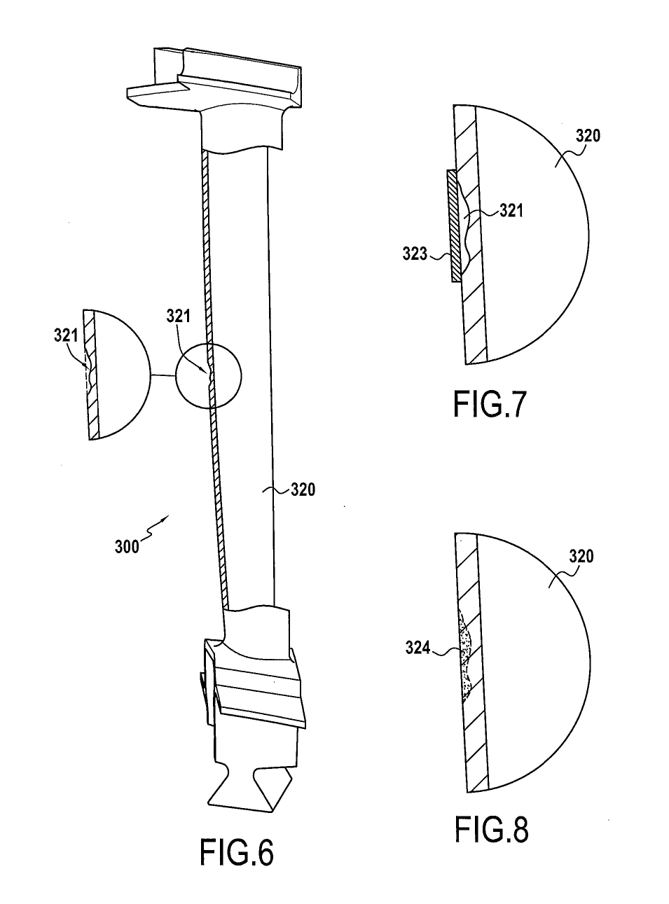

With reference to FIGS. 6 to 8, there follows a description of an implementation of a method in accordance with the invention for repairing an aeroengine blade 300 made of thermostructural composite material comprising reinforcement obtained by three-dimensional or multilayer weaving of SiC yarns to form a single piece and densified by a matrix likewise made of SiC. The blade 300 presents a damaged zone 321 in its airfoil 320 as a result of an impact, and giving rise to a surface defect of the airfoil that needs to be filled in. For this purpose, and in accordance with an implementation of the method of the invention, a pellet 323 of an infiltration composition based on silicon is placed on the damaged zone 321, the quantity of composition being sufficient for filling in the damaged zone. The blade and the pellet are then heated to a temperature enabling the pellet 323 to be melted and enabling the infiltration composition to spread in the damaged zone. After cooling, a blade 300 is obtained that presents a surface level that is regular as a result of the presence of a filler material 324 constituted by the infiltration composition 323.

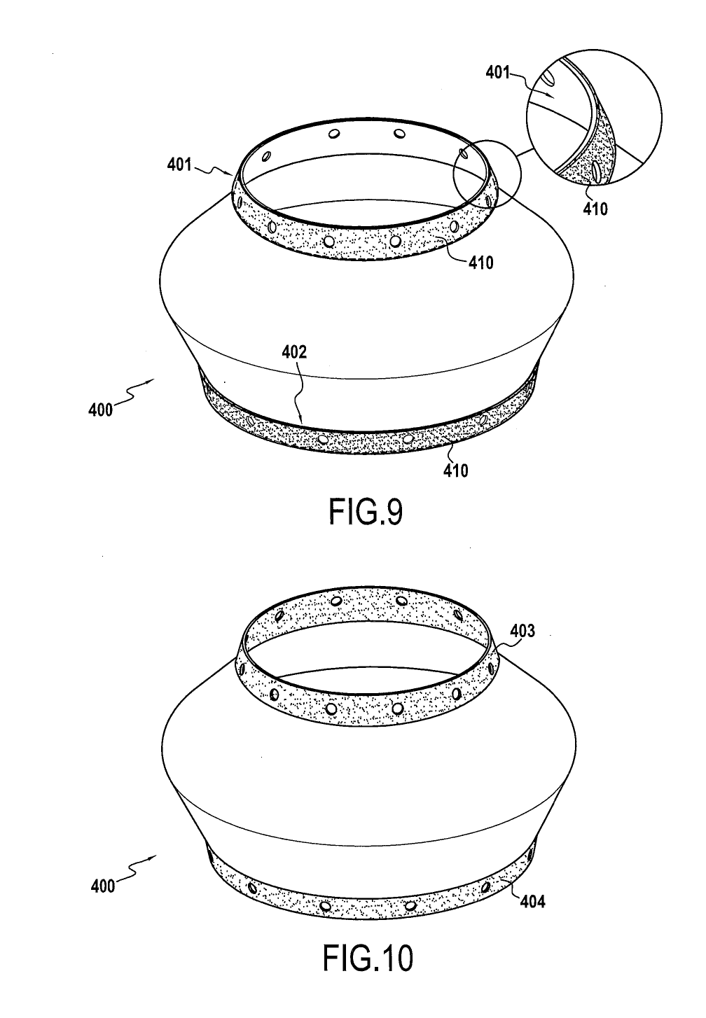

There follows a description of an implementation of the invention for locally reinforcing mechanical connection portions of a part made of composite material. FIG. 9 shows a structural part 400 in the form of a body of revolution having flanges 401 and 402 for mechanical connection. In the presently-described example, the structural part 400 is made of carbon fiber reinforcement densified with a matrix that is also made of carbon.

In accordance with the method of the invention, a determined quantity of silicon-based infiltration composition 410 is placed on each of the portions corresponding to the mechanical connection flanges 401 and 402 in order to infiltrate the zones occupied by the connection flanges. In the presently-described example, the infiltration composition is in the form of a powder mixed with a sacrificial binder serving to enable it to be applied on the zones for infiltrating, e.g. by using a brush. The part 400 together with the composition is then raised to a temperature that is high enough to melt the infiltration composition, which diffuses in the pores of the composite material in its zones that correspond to the connection flanges 401 and 402. After cooling, and as shown in FIG. 10, the structural part 400 has reinforced portions 403 and 404 constituting its mechanical connection flanges, thereby providing the part with greater strength in its connection zones, in particular for withstanding clamping and crushing forces, the connection working mainly in shear.

The method of the invention may also be used for treating a composite material part having at least one bearing surface portion that is to come into contact with a metal sealing part, the bearing surface portion corresponding to a portion to be treated. As described above for locally reinforcing mechanical connection portions, the bearing surface portion(s) is/are covered in a silicon-based infiltration composition that is subsequently melted in order to infiltrate the composite material of the part in the bearing surface portion(s) to be reinforced.

A part is thus obtained having one or more bearing surface portions that are better at withstanding friction against a metal part, thereby ensuring that sealing is maintained over time. Furthermore, when the composite material of the part has a matrix that is self-healing, i.e. with boron or a boron compound, the infiltration of the bearing surface portions serves to avoid interactions between boron and the metal material(s) of the sealing part.

The infiltration composition used in the treatment method of the invention comprises silicon or a silicon alloy such as, for example: SiTi, SiMo, or SiNB. The infiltration composition may in particular correspond to a silicon-based brazing composition used for assembling together parts made of composite material. Silicon-based brazing compositions are described in particular in Documents EP 0 806 402 or U.S. Pat. No. 5,975,407. The kind of infiltration composition selected depends in particular on chemical compatibility and on its coefficient of thermal expansion compared with the material of the part to be infiltrated.

1. A method of locally treating a portion of a part made of composite material comprising fiber reinforcement densified by a matrix, said material presenting internal pores, the method comprising:
determining a quantity of infiltration composition as a function of a volume of the portion of the part to be treated, the infiltration composition comprising at least silicon;
placing the determined quantity of infiltration composition in contact with pores opening out in a surface of the portion of the part to be treated; and
applying heat treatment at a temperature higher than or equal to a melting temperature of the infiltration composition so as to impregnate said portion with the treatment composition and fill in the pores present in said portion.

2. A method according to claim 1, wherein the infiltration composition comprises silicon or a silicon alloy.

3. A method according to claim 1, further comprising machining the portion of the treated part.

4. A method according to claim 1, wherein the part is made of ceramic matrix thermostructural composite material.

5. A method according to claim 1, wherein the part made of composite material corresponds to an aeroengine blade comprising at least a blade root and an airfoil, and wherein the portion for treatment corresponds to the blade root of said blade.

6. A method according to claim 1, wherein the composite material part corresponds to a structural part having at least one connection portion for mechanically connecting to another part, and wherein each connection portion corresponds to a portion to be treated.

7. A method according to claim 1, wherein the composite material part corresponds to a structural part having at least one bearing surface portion that is to come into contact with a sealing part made of metal, and wherein in that each bearing surface portion corresponds to a portion to be treated.

8. A method of repairing a part made of composite material, the part including at least one damaged portion in its surface, the method comprising treating each damaged portion in accordance with the treatment method according to claim 1.
